(19) United States
(12) Patent Application Publication
(10) Pub. No.: US 2001/0026416 A1
(43) Pub. Date: Oct. 4, 2001

(54) Magnetic storage and head unload controlling method of magnetic storage

(75) Inventor: Yasushi Teshigawara, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/820,785

(22) Filed: Mar. 30, 2001

(30) Foreign Application Priority Data
Mar. 30, 2000 (JP) 2000-095396

(51) Int. Cl. G11B 21/02

(52) U.S. Cl. 360/75

(57) ABSTRACT

A magnetic storage for reading and writing data from and into a medium, comprising: a medium for storing data; a magnetic head; a spindle motor; a controller for controlling unload of the magnetic head and spin-down of the spindle motor while monitoring data access to the medium through the magnetic head; and a voice coil motor, in which the controller increases head unload time by a first predetermined value, if there occurs data access after elapses of the head unload time, when data access is performed with the initial value of the time defined as X, the time meaning a period from a time of finishing data access to a time of head unload, and further increases the head unload time by the first predetermined value repeatedly until data access occurs within the head unload time.

### BACKGROUNDS OF THE INVENTION

1. Field of the Invention

The present invention relates to a head unload controlling method of a magnetic storage, and more particularly to a control method for reducing the number of the times of head unload operations in a magnetic storage and a magnetic storage for performing the same control.

2. Description of the Related Art

In the recent hard disk unit and flexible disk unit, a lot of them are designed to stop the magnetic head outside of a medium and also stop the rotation of a medium at a time of no data access, for the reason of improving power management, shock-resistant ability, and endurance limit of a head and a medium. Especially, a flexible disk unit of large volume uses this stopping operation more frequently than a hard disk unit.

In a magnetic storage, data is not always read and written, but it is done only at a time of necessity. At the other time when no data access is performed, the magnetic head is arbitrarily moving on the medium or standing at a given position on the medium, or the magnetic head moves to a position of non-operation where the rotation of the medium is stopped.

When reading and writing data from and into the magnetic storage, there is a case of reading and writing small data intermittently and repeatedly, instead of continuous data access, in relation to the data transfer speed at a side of a host sending and receiving data. At this time, depending on a combination of a using magnetic storage and a host, there may occur a case where the head of the magnetic storage may fall into repetition of load/unload.

For example, assume that a magnetic storage is set to be unloaded if it has no data-access for three seconds. When the music data such as MP3 file (the sound file format compressed by the MPEG Audio Layer-3 standard) is read out from this magnetic storage and reproduced, there is a case where a space of three seconds and more may occur from a time of reading some data to a time of reading the next data. In this case, there occur the following problems.

As a first problem, since a magnetic head is once unloaded and loaded again to read data repeatedly, it takes much time to position the magnetic head at a target position, thereby prolonging the access time of the data. This is because even if an instruction for requesting data access is given by a host and if during the head unload operation, the instruction is not accomplished, in a wait state, until the operation has been completed.

As a second problem, repetition of load/unload shortens the life of a head or a medium. This is because the operation of load/unload shocks a head and a medium. As a third problem, if setting an unload time and spindle shutdown time, a loss of power consumption is increased. This is because since the interval of reading data depends on the cache size and using software and OS of a computer at a side of a host, it is necessary to set the unload time and spindle shutdown time much longer in order to make the time fixed at the timing capable of avoiding this phenomenon.

### SUMMARY OF THE INVENTION

An object of the present invention is to provide a method of controlling head unload of a magnetic storage and a magnetic storage itself improved in data access speed to a magnetic disk unit from a host in the case where intermittent data access to the magnetic disk unit continues.

Another object of the present invention is to provide a method of controlling head unload of a magnetic storage and a magnetic storage itself capable of prolonging the life of a head and a medium of a magnetic disk unit.

According to the first aspect of the invention, a magnetic storage for accessing data to a magnetic storing medium, comprises

the medium for storing the data,

a magnetic head for accessing the data stored in the medium,

a spindle motor for rotating the medium,

a controller for controlling unload of the magnetic head and spin-down of the spindle motor while monitoring data access to the medium through the magnetic head, and

a voice coil motor for moving the magnetic head for load/unload and data access, wherein

the controller

increases head unload time by a first predetermined value, if there occurs no data access within the head unload time, when data access is performed with the initial value of the head unload time defined as X, the head unload time meaning a period from a time of finishing data access to a time of head unload, and further increases the head unload time by the first predetermined value repeatedly until data access occurs within the head unload time.

A head unload method of a magnetic storage according to the present invention is to shorten the data access time and to reduce the number of the times of useless load/unload of a head, by automatically prolonging a wait hour for head unload when having data access from a host of a computer to the magnetic storage repeatedly at regular intervals.

In the preferred construction, the controller increases the head unload time by the first predetermined value and increases spin-down time by a second predetermined value, if there occurs no data access within the head unload time, when data access is performed with the initial value of the head unload time defined as X and the initial value of spin-down time defined as Y, the spin-down time meaning a period from a time of finishing data access to a time of spin-down.

In another preferred construction, the controller includes a time counter which is reset by data access and starts counting time by the completion of the data access, a head park time detecting unit which stores the head unload time X and controls the voice coil motor to move the magnetic head to a load lamp positioned outside of the medium, when the count value of the time counter exceeds the above time X, a spin-down time detecting unit which stores the predetermined time Y and stops the spindle motor, when the count value of the time counter exceeds the above time Y, and a controlling circuit which monitors an access instruction from an upper device, judges whether there is data access or not, and changes the values of the above X and Y.

According to the second aspect of the invention, a magnetic storage for accessing data to a magnetic storing medium, comprise

the medium for storing the data,

a magnetic head for accessing the data stored in the medium,

a spindle motor for rotating the medium,

a controller for controlling unload of the magnetic head and spin-down of the spindle motor while monitoring data access to the medium through the magnetic head,

a voice coil motor for moving the magnetic head for load/unload and data access,

a time counter of being reset by data access and starting counting time by the completion of the data access,

a head park time detecting unit, having the head unload time X stored, for controlling the voice coil motor to move the magnetic head to a load lamp positioned outside of the medium, when the count value of the time counter exceeds the above time X,

a spin-down time detecting unit, having the predetermined time Y stored, for stopping the spindle motor, when the count value of the time counter exceeds the above time Y, and

a controlling circuit for monitoring an access instruction from an upper device, judging whether there is data access or not, and changing the values of the above X and Y,

wherein the controller increases head unload time by a first predetermined value, if there occurs no data access within the head unload time, when data access is performed with the initial value of the head unload time defined as X′, the head unload time meaning a period from a time of finishing data access to a time of head unload, and further increases the head unload time by the first predetermined value repeatedly until data access occurs within the head unload time, and increases the head unload time by the first predetermined value and increases spin-down time by a second predetermined value, if there occurs no data access within the head unload time, when data access is performed with the initial value of the head unload time defined as X′ and the initial value of spin-down time defined as Y′, the spin-down time meaning a period from a time of finishing data access to a time of spin-down.

According to the third aspect of the invention, a magnetic storage for reading and writing data from and to a magnetic storing medium, comprises

the medium for storing the data,

a magnetic head for reading and writing the data stored in the medium,

a spindle motor for rotating the medium,

a controller for controlling unload of the magnetic head and spin-down of the spindle motor while monitoring the data access to the medium through the magnetic head, and

a voice coil motor for moving the magnetic head for load/unload and data access, in which

the controller updates the head unload time to a value obtained by adding a predetermined allowance value t0 to time t, if the next data access occurs later than the last data access by the time t after elapse of the head unload time, when data access is performed with the initial value of the head unload time defined as X1.

In the preferred construction, the controller

updates the head unload time to a value obtained by adding a predetermined allowance value t0 to time t and updates the spin-down time to a value obtained by adding the difference t X between the time t and the current head unload time X and allowance value t0 to the current spin-down time Y, if the next data access occurs later than the last data access by the time t after elapse of the head unload time, when data access is performed with the initial value of the head unload time defined as X1 and the initial value of the spin-down time defined as Y1.

In another preferred construction, the controller includes a time counter which is reset by data access and starts counting time by the completion of the data access, a head park time detecting unit which stores the predetermined time X and controls the voice coil motor to move the magnetic head to a load lamp positioned outside of the medium, when the time of the time counter exceeds the above predetermined time X, a spin-down time detecting unit which stores the predetermined time Y and stops the spindle motor, when the time of the time counter exceeds the above predetermined time Y, and a controlling circuit which monitors an access instruction from an upper device to judge whether there is data access or not, detects the time t from the last data access to the next data access, and changes the values of the above X and Y.

According to another aspect of the invention, a magnetic storage for reading and writing data from and into a magnetic storing medium, comprises

the medium for storing the data,

a magnetic head for reading and writing the data stored in the medium,

a spindle motor for rotating the medium,

a controller for controlling unload of the magnetic head and spin-down of the spindle motor while monitoring the data access to the medium through the magnetic head,

a voice coil motor for moving the magnetic head for load/unload and data access,

a time counter of being reset by data access and starting counting by the completion of the data access,

a head park time detecting unit, having the head unload time X stored, for controlling the voice coil motor to move the magnetic head to a load lamp positioned outside of the medium, when the time of the time counter exceeds the above time X,

a spin-down time detecting unit, having the predetermined time Y stored, for stopping the spindle motor, when the time of the time counter exceeds the above predetermined time Y, and

a controlling circuit for monitoring an access instruction from an upper device, judging whether there is data access or not, detecting the time t from the last data access to the next data access, and changing the values of the above X and Y,

wherein the controller updates the head unload time to a value obtained by adding a predetermined allowance value t0 to time t, if the next data access occurs later than the last data access by the time t after elapse of the head unload time, when data access is performed with the initial value of the head unload time defined as X1, and updates the head unload time to a value obtained by adding a predetermined allowance value t0 to the time t and updates the spin-down time to a value obtained by adding the difference t X2′ between the time t and the current head unload time X2′ and allowance value t0 to the current spin-down time Y2′, if the next data access occurs later than the last data access by the time t after elapse of the head unload time, when data access is performed with the initial value of the head unload time defined as X2 and the initial value of the spin-down time defined as Y2.

According to a further aspect of the invention, a head unload controlling method of a magnetic storage having a medium for storing data, a magnetic head for reading and writing the data stored in the medium, a spindle motor for rotating the medium, a controller for controlling unload of the magnetic head and spin-down of the spindle motor while monitoring data access to the medium through the magnetic head, and a voice coil motor for moving the magnetic head for load/unload, comprising the following step of

increasing head unload time by a predetermined value, if there occurs head unload before the data access, when data access is performed with the initial value of the head unload time defined as X, the head unload time meaning a period from a time of finishing data access to a time of head unload, and further increasing the head unload time by the predetermined value repeatedly until data access occurs within the head unload time.

According to a further aspect of the invention, a head unload controlling method of a magnetic storage having a medium for storing data, a magnetic head for reading and writing the data stored in the medium, a spindle motor for rotating the medium, a controller for controlling unload of the magnetic head and spin-down of the spindle motor while monitoring data access to the medium through the magnetic head, and a voice coil motor for moving the magnetic head for load/unload, comprising the following steps of

waiting for the completion of the data access operation and checking whether the data access is completed,

checking whether there is the next data access before elapse of the unload time X of the magnetic head when the data access is completed,

performing the data access operation, waiting for the completion of the next data access when there is data access, and adding the predetermined values X1 and Y1 respectively to the head unload time X and the spin-down time Y from the next time when there is no data access,

unloading the magnetic head to a load lamp outside of the medium,

checking whether there is data access within the time of stopping the spindle motor, and

performing the data access operation, keeping the already changed values X and Y as they are, and waiting for the next data access when there is data access, and returning the head unload time X and the spin-down time Y to the predetermined initial values X0 and Y0 from the next time and stopping the spindle motor when there is no data access.

According to a still further aspect of the invention, a head unload controlling method of a magnetic storage having a medium for storing data, a magnetic head for reading and writing the data stored in the medium, a spindle motor for rotating the medium, a controller for controlling unload of the magnetic head and spin-down of the spindle motor while monitoring data access to the medium through the magnetic head, and a voice coil motor for moving the magnetic head for load/unload, comprising the following step of

updating the head unload time to a value obtained by adding a predetermined allowance value t0 to time t, if the next data access occurs later than the last data access by the time t after elapse of the head unload time, when data access is performed with the initial value of the head unload time defined as X1.

According to a still further aspect of the invention, a head unload controlling method of a magnetic storage having a medium for storing data, a magnetic head for reading and writing the data stored in the medium, a spindle motor for rotating the medium, a controller for controlling unload of the magnetic head and spin-down of the spindle motor while monitoring data access to the medium through the magnetic head, and a voice coil motor for moving the magnetic head for load/unload, comprising the following steps of

waiting for the completion of the data access operation and checking whether the data access is completed,

checking whether there is the next data access before elapse of the unload time X of the magnetic head when the data access is completed,

performing the data access operation, waiting for the completion of the next data access when there is data access, and unloading the magnetic head to a load lamp outside of the medium when there is no data access,

checking whether there is data access within the time of stopping the spindle motor, and

updating the spin-down time Y1 to a value obtained by adding the difference t X between the time t from the last data access to the next data access and the current head unload time X and a value t0 for taking predetermined allowance to the current spin-down time Y, setting the next head unload time X1 at t t0, performing the next data access operation, and waiting for the next data access when there is data access, and returning the head unload time X and the spin-down time Y to the predetermined initial values X0 and Y0 from the next time and stopping the spindle motor when there is no data access.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a view showing the relationship between the head unload time X and the spindle shutdown time Y according to the present invention;

FIG. 2 is a block diagram showing the structures of a first embodiment and a second embodiment of the present invention;

FIG. 3 is a flow chart showing the control procedure of the first embodiment of the present invention;

FIG. 4 is a view for use in describing the operation concept of the first embodiment:

FIG. 4(a) shows the case where the head unload time (length of the period a) is the initial value;

FIG. 4(b) shows the case where the period a is extended; and

FIG. 4(c) shows the case where the period a is further extended;

FIG. 5 is a view for use in describing the operation concept of the second embodiment of the present invention;

FIG. 6 is a flow chart showing the control procedure of the second embodiment of the present invention.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

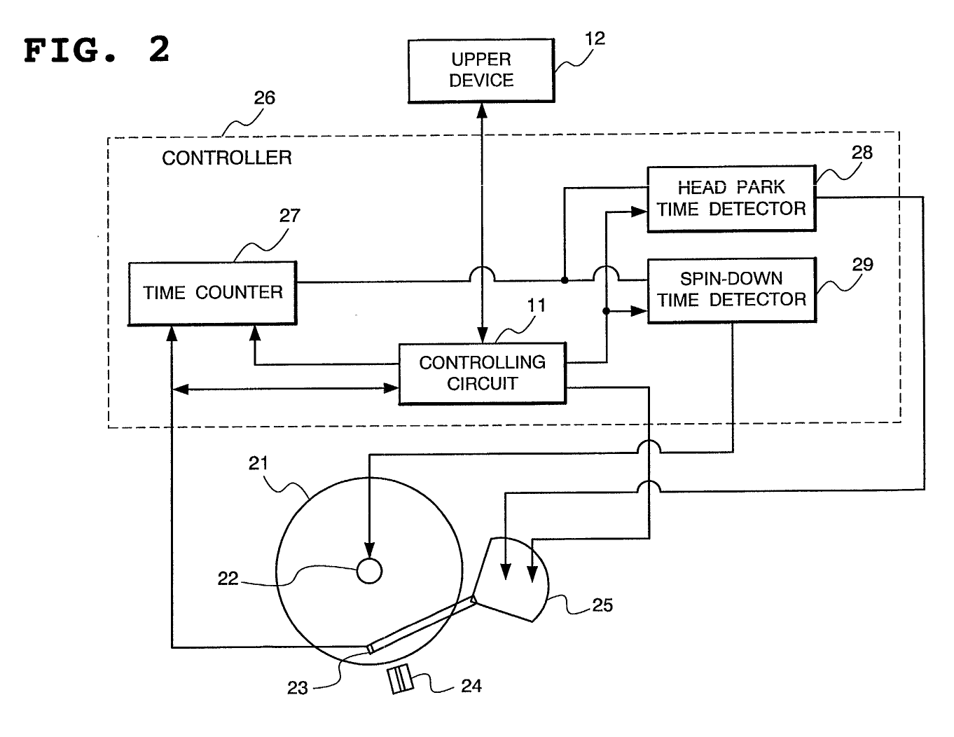

With reference to FIG. 2, the first embodiment of the present invention comprises a medium 21 for storing data, a magnetic head 23 for reading and writing data, a spindle motor 22 for rotating the medium 21, a controller 26 for controlling unload of the magnetic head 23 and spin-down (rotation stop) of the spindle motor 22 while monitoring data access to the medium 21 through the magnetic head 23, and a voice coil motor 25 for moving the magnetic head 23 for load/unload and data access.

The controller 26 monitors the data access to the medium 21 through the magnetic head 23 and includes a time counter 27 which is reset by reading and writing of the data, namely data access, and starts counting upon completion of reading and writing (completion of data access).

A predetermined time X is stored in a head park time detector 28. When the time of the time counter 27 becomes larger than the above predetermined time, the head park time detector 28 controls the voice coil motor 25 so as to move the magnetic head 23 to a load lamp 24 positioned outside of the medium.

Similarly, a predetermined time Y is stored in a spin-down time detector 29. When the time of the time counter 27 becomes larger than the predetermined time, the spin-down time detector 29 controls the spindle motor 22 to stop.

Here, X and Y are selected so as to satisfy the relation of Y X so that the spin-down should not precede the head unload. A controlling circuit 11 controls the whole of the controller 26, monitoring an access instruction from an upper device 12 to judge whether there is data access or not, and changing the above values of X and Y.

The operation of the first embodiment of the present invention constituted as mentioned above will be described this time.

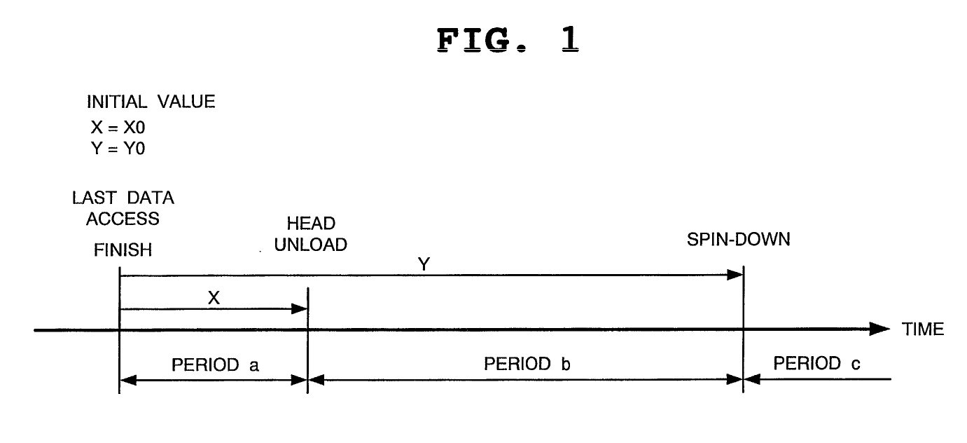

At first, the outline of the operation will be described with reference to FIG. 1. In FIG. 1, when there is no next access after elapse of the predetermined unload time X since an access is completed, the unload time X and the spindle shutdown time Y for the next time will be prolonged by a constant value. When there is no next access after elapse of the spindle shutdown time, the above two times X and Y are returned to the initial values. When the next data access is to be made within the period b of FIG. 1, since the above two times X and Y are extended, if the data access within the period b is repeated, the period a is more and more extended, and at the last, data access will be is made without unloading the head.

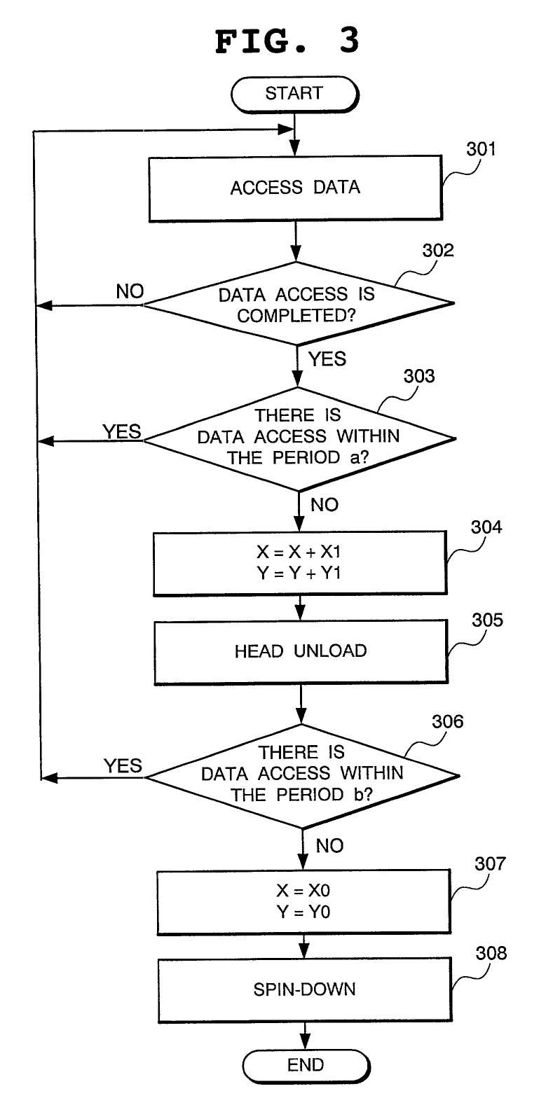

The operation of the first embodiment of the present invention will be further described in detail by using FIG. 3. FIG. 3 is a flow chart showing the operation of the controller 26 in the first embodiment. In the embodiment, the magnetic head 23 is arranged to stay on the medium 21 during a predetermined hour even if finishing the data access to the medium 21.

When having data access, the controlling circuit 11 controls the voice coil motor 25 and the magnetic head 23 to do the data access operation and waits for the next data access to be completed (Step 301). It judges whether the data access is completed or not based on the data obtained through the magnetic head 23 (Step 302). When it is completed, it checks whether there is the next data access within the time (period a) of unloading the magnetic head 23, based on the presence of an access instruction from the upper device 12 (Step 303).

When having data access, the controlling circuit 11 makes the operation of the data access performed and waits for the next data access to be completed (Step 301). If the data access is completed, the time counter 27 is reset at this time and the unload and spindle shutdown operations which have not been executed are cancelled. When having no data access, the controlling circuit 11 adds the respectively determined values X1 and Y1 to the head unload time X of the head park time detector 28 and the spin-down time Y of the spin-down time detector 29 from the next time (Step 304).

At this time, the magnetic head 23 is unloaded to the load lamp 24 outside of the medium 21 (Step 305). At this point, the spindle motor is still rotating. Here, X1 and Y1 should be selected so as to satisfy X1 Y1. Otherwise, there may occur a disadvantageous case where X Y.

The controlling circuit 11 checks whether there is data access within the time (period b) of stopping the spindle motor 22 (Step 306). When there is data access, it controls the data access operation and waits for the next data access to be completed while keeping the changed values X and Y as they are (Step 301). When there is no data access, the controlling circuit 11 returns the head unload time X and the spin-down time Y to some established initial values X0 and Y0 from the next time (Step 307) and stops the spindle (Step 308).

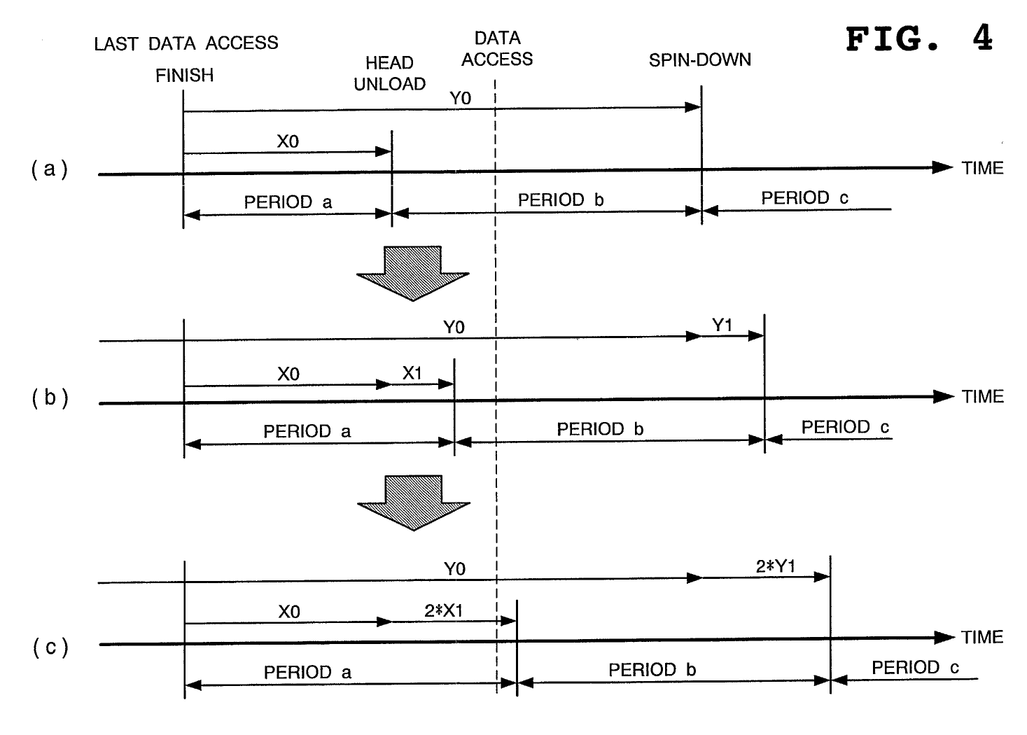

The operation concept of the controller 26 will be described by using FIG. 4. Assume that data access to the magnetic storage from the upper device 12 of a computer is intermittently made at regular intervals. Considered is the case of having the next data access at a position shown by the broken line in FIG. 4 after a predetermined elapse of time from the last data access (the state of FIG. 4(a)). In this case, since there is no data access within the period a, namely, there is no data access before the elapse of X0 from the last data access, the magnetic head 23 is unloaded.

This is, however, in the case of having data access within the period b (the case of having data access before the elapse of the spin-down scheduled time Y0). Therefore, by using the control method according to the present invention, the next head unload time and spin-down time are respectively prolonged by X1 and Y1 (the state of FIG. 4(b)). Even in this case, since the point of having the next data access is not within the period a in FIG. 4(b) and the data access happens after the elapse of the time X0+X1, the magnetic head 23 is still unloaded. If the head unload time and the spin-down time are prolonged by X1 and Y1 once again, it will be in the state of FIG. 4(c). In this state, data access will be made within the period a, without unloading the magnetic head 23.

This time, a second embodiment of the present invention will be described.

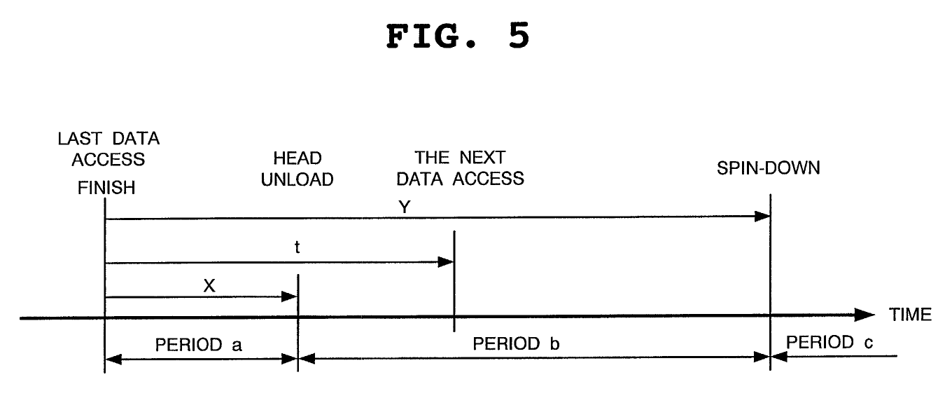

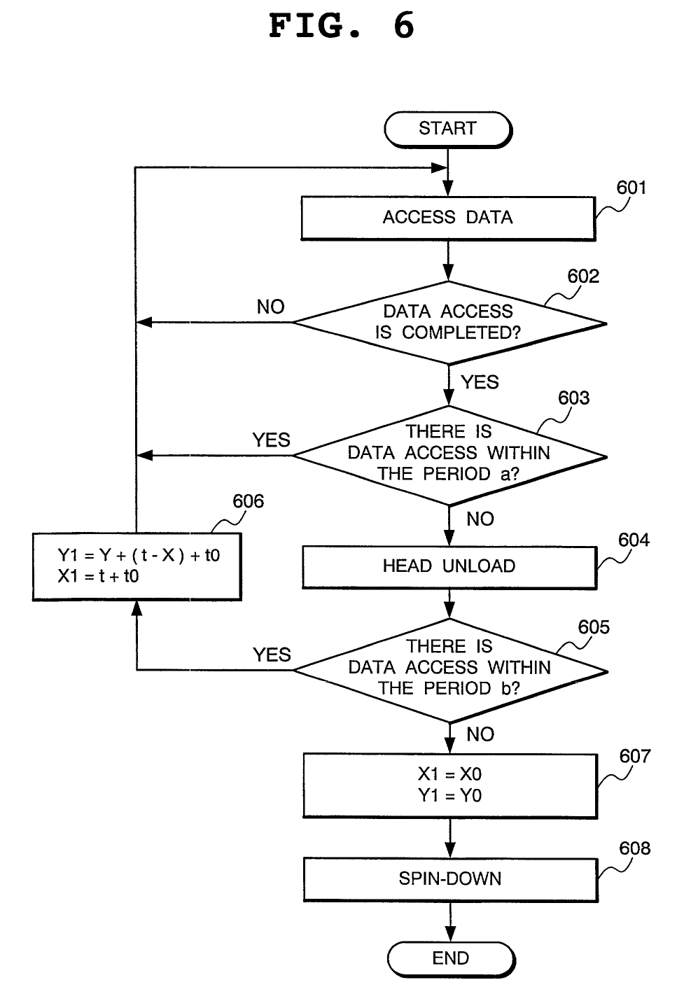

When the time t from the completion of one data access to the next data access can be accurately grasped, a method of preventing head unload without fail by using the time t can be considered, which will be described as follows by using FIGS. 5 and 6.

As illustrated in FIG. 5, assume that the time from the last data access to the next data access is defined as t, the current head unload time is defined as X, and that the current spin-down time is defined as Y. FIG. 6 is a flow chart showing the operation of the controller 26 in the above second embodiment.

When having data access, the controlling circuit 11 controls the voice coil motor 25 and the magnetic head 23 to do the data access operation and waits for the next data access to be completed (Step 601). It judges whether the data access is completed or not based on the data obtained through the magnetic head 23 (Step 602). When it is completed, it checks whether there is the next data access within the time (period a) of unloading the magnetic head 23, based on the presence of an access instruction from the upper device 12 (Step 603).

When having data access, the controlling circuit 11 makes the operation of the data access performed and waits for the next data access to be completed (Step 601). If the data access is completed, the time counter 27 is reset at this time and the unload operation and the spindle shutdown operation which have not been executed are cancelled. When there is no data access, the magnetic head 23 is unloaded to the load lamp 24 (Step 604). At this point, the spindle motor is still rotating.

The controlling circuit 11 checks whether there is data access within the time (period b) of stopping the spindle motor 22 (Step 605). When there is data access, the controlling circuit 11 defines the next spin-down time Y1 as the value obtained by adding the difference t X between the time t from the last data access to the next data access and the current head unload time X (time length of the period a) and the value t0 for making some predetermined allowance to the current spin-down time Y, and sets the next head unload time X1 at t t0 (Step 606). It waits for the next data access to be completed (Step 601).

When having no data access, the controlling circuit 11 returns the head unload time X1 and the spin-down time Y1 to some established initial values X0 and Y0 from the next time (Step 607) and stops the spindle (Step 608).

Use of the second embodiment is effective in coming into the state of preventing the magnetic head 23 from unload without trial and error. Instead, it is necessary for the controlling circuit 11 to have a function of accurately monitoring the time period till the completion of the data access based on the value of the time counter 27 and detecting the time t from the last data access to the next data access.

As the present invention has been constituted and operated in the above, when an intermittent data access is continued in a magnetic disk unit, it is possible to speed up the data access to the magnetic disk unit from a host. When a head is unloaded, no access to the data is permitted until it is loaded even if the upper device makes an access request. Although it is necessary to wait for the head to be loaded, the head unload time is adjusted so as not to fall into the head unload state, thereby saving the wait time for the head load state.

According to the present invention, the life of a head and a medium of the magnetic disk unit can be improved. This is because repetition of load/unload operations at every data access can be prevented in the case where intermittent data access continues, thereby decreasing the number of the times of the load/unload operations.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A magnetic storage for accessing data to a magnetic storing medium, comprising:
said medium for storing the data;
a magnetic head for accessing the data stored in said medium;
a spindle motor for rotating said medium;
a controller for controlling unload of said magnetic head and spin-down of said spindle motor while monitoring data access to said medium through said magnetic head; and
a voice coil motor for moving said magnetic head for load/unload and data access, wherein
said controller
increases head unload time by a first predetermined value, if there occurs no data access within the head unload time, when data access is performed with the initial value of the head unload time defined as X, the head unload time meaning a period from a time of finishing data access to a time of head unload, and further increases the head unload time by the first predetermined value repeatedly until data access occurs within the head unload time.

2. A magnetic storage as set forth in claim 1, wherein
said controller
increases the head unload time by the first predetermined value and increases spin-down time by a second predetermined value, if there occurs no data access within the head unload time, when data access is performed with the initial value of the head unload time defined as X and the initial value of spin-down time defined as Y, the spin-down time meaning a period from a time of finishing data access to a time of spin-down.

3. A magnetic storage as set forth in claim 1, wherein
said controller includes:
a time counter which is reset by data access and starts counting time by the completion of the data access;
a head park time detecting unit which stores the head unload time X and controls said voice coil motor to move said magnetic head to a load lamp positioned outside of said medium, when the count value of said time counter exceeds the above time X;
a spin-down time detecting unit which stores the predetermined time Y and stops said spindle motor, when the count value of said time counter exceeds the above time Y; and
a controlling circuit which monitors an access instruction from an upper device, judges whether there is data access or not, and changes the values of the above X and Y.

4. A magnetic storage for accessing data to a magnetic storing medium, comprising:
said medium for storing the data;
a magnetic head for accessing the data stored in said medium;
a spindle motor for rotating said medium;
a controller for controlling unload of said magnetic head and spin-down of said spindle motor while monitoring data access to said medium through said magnetic head;
a voice coil motor for moving said magnetic head for load/unload and data access;
a time counter of being reset by data access and starting counting time by the completion of the data access;
a head park time detecting unit, having the head unload time X stored, for controlling said voice coil motor to move said magnetic head to a load lamp positioned outside of said medium, when the count value of said time counter exceeds the above time X;
a spin-down time detecting unit, having the predetermined time Y stored, for stopping said spindle motor, when the count value of said time counter exceeds the above time Y; and
a controlling circuit for monitoring an access instruction from an upper device, judging whether there is data access or not, and changing the values of the above X and Y,
wherein said controller
increases head unload time by a first predetermined value, if there occurs no data access within the head unload time, when data access is performed with the initial value of the head unload time defined as X′, the head unload time meaning a period from a time of finishing data access to a time of head unload, and further increases the head unload time by the first predetermined value repeatedly until data access occurs within the head unload time, and
increases the head unload time by the first predetermined value and increases spin-down time by a second predetermined value, if there occurs no data access within the head unload time, when data access is performed with the initial value of the head unload time defined as X′ and the initial value of spin-down time defined as Y′, the spin-down time meaning a period from a time of finishing data access to a time of spin-down.

5. A magnetic storage for reading and writing data from and to a magnetic storing medium, comprising:
said medium for storing the data;
a magnetic head for reading and writing the data stored in said medium;
a spindle motor for rotating said medium;
a controller for controlling unload of said magnetic head and spin-down of said spindle motor while monitoring the data access to said medium through said magnetic head; and
a voice coil motor for moving said magnetic head for load/unload and data access, in which
said controller
updates the head unload time to a value obtained by adding a predetermined allowance value t0 to time t, if the next data access occurs later than the last data access by the time t after elapse of the head unload time, when data access is performed with the initial value of the head unload time defined as X1.

6. A magnetic storage as set forth in claim 5, wherein
said controller
updates the head unload time to a value obtained by adding a predetermined allowance value t0 to time t and updates the spin-down time to a value obtained by adding the difference t X between the time t and the current head unload time X and allowance value t0 to the current spin-down time Y, if the next data access occurs later than the last data access by the time t after elapse of the head unload time, when data access is performed with the initial value of the head unload time defined as X1 and the initial value of the spin-down time defined as Y1.

7. A magnetic storage as set forth in claim 5, wherein
said controller includes:
a time counter which is reset by data access and starts counting time by the completion of the data access;
a head park time detecting unit which stores the predetermined time X and controls said voice coil motor to move said magnetic head to a load lamp positioned outside of said medium, when the time of said time counter exceeds the above predetermined time X;
a spin-down time detecting unit which stores the predetermined time Y and stops said spindle motor, when the time of said time counter exceeds the above predetermined time Y; and
a controlling circuit which monitors an access instruction from an upper device to judge whether there is data access or not, detects the time t from the last data access to the next data access, and changes the values of the above X and Y.

8. A magnetic storage for reading and writing data from and into a magnetic storing medium, comprising:
said medium for storing the data;
a magnetic head for reading and writing the data stored in said medium;
a spindle motor for rotating said medium;
a controller for controlling unload of said magnetic head and spin-down of said spindle motor while monitoring the data access to said medium through said magnetic head;
a voice coil motor for moving said magnetic head for load/unload and data access;
a time counter of being reset by data access and starting counting by the completion of the data access;
a head park time detecting unit, having the head unload time X stored, for controlling said voice coil motor to move said magnetic head to a load lamp positioned outside of said medium, when the time of said time counter exceeds the above time X;
a spin-down time detecting unit, having the predetermined time Y stored, for stopping said spindle motor, when the time of said time counter exceeds the above predetermined time Y; and
a controlling circuit for monitoring an access instruction from an upper device, judging whether there is data access or not, detecting the time t from the last data access to the next data access, and changing the values of the above X and Y,
wherein said controller
updates the head unload time to a value obtained by adding a predetermined allowance value t0 to time t, if the next data access occurs later than the last data access by the time t after elapse of the head unload time, when data access is performed with the initial value of the head unload time defined as X1, and
updates the head unload time to a value obtained by adding a predetermined allowance value t0 to the time t and updates the spin-down time to a value obtained by adding the difference t X2′ between the time t and the current head unload time X2′ and allowance value t0 to the current spin-down time Y2′, if the next data access occurs later than the last data access by the time t after elapse of the head unload time, when data access is performed with the initial value of the head unload time defined as X2 and the initial value of the spin-down time defined as Y2.

9. A head unload controlling method of a magnetic storage having a medium for storing data, a magnetic head for reading and writing the data stored in said medium, a spindle motor for rotating said medium, a controller for controlling unload of said magnetic head and spin-down of said spindle motor while monitoring data access to said medium through said magnetic head, and a voice coil motor for moving said magnetic head for load/unload, comprising the following step of:
increasing head unload time by a predetermined value, if there occurs head unload before the data access, when data access is performed with the initial value of the head unload time defined as X, the head unload time meaning a period from a time of finishing data access to a time of head unload, and further increasing the head unload time by the predetermined value repeatedly until data access occurs within the head unload time.

10. A head unload controlling method of a magnetic storage having a medium for storing data, a magnetic head for reading and writing the data stored in said medium, a spindle motor for rotating said medium, a controller for controlling unload of said magnetic head and spin-down of said spindle motor while monitoring data access to said medium through said magnetic head, and a voice coil motor for moving said magnetic head for load/unload, comprising the following steps of:
waiting for the completion of the data access operation and checking whether the data access is completed;
checking whether there is the next data access before elapse of the unload time X of said magnetic head when the data access is completed;
performing the data access operation, waiting for the completion of the next data access when there is data access, and adding the predetermined values X1 and Y1 respectively to the head unload time X and the spin-down time Y from the next time when there is no data access;
unloading said magnetic head to a load lamp outside of said medium;
checking whether there is data access within the time of stopping said spindle motor; and
performing the data access operation, keeping the already changed values X and Y as they are, and waiting for the next data access when there is data access, and returning the head unload time X and the spin-down time Y to the predetermined initial values X0 and Y0 from the next time and stopping said spindle motor when there is no data access.

11. A head unload controlling method of a magnetic storage having a medium for storing data, a magnetic head for reading and writing the data stored in said medium, a spindle motor for rotating said medium, a controller for controlling unload of said magnetic head and spin-down of said spindle motor while monitoring data access to said medium through said magnetic head, and a voice coil motor for moving said magnetic head for load/unload, comprising the following step of:
updating the head unload time to a value obtained by adding a predetermined allowance value t0 to time t, if the next data access occurs later than the last data access by the time t after elapse of the head unload time, when data access is performed with the initial value of the head unload time defined as X1.

12. A head unload controlling method of a magnetic storage having a medium for storing data, a magnetic head for reading and writing the data stored in said medium, a spindle motor for rotating said medium, a controller for controlling unload of said magnetic head and spin-down of said spindle motor while monitoring data access to said medium through said magnetic head, and a voice coil motor for moving said magnetic head for load/unload, comprising the following steps of:
waiting for the completion of the data access operation and checking whether the data access is completed;
checking whether there is the next data access before elapse of the unload time X of said magnetic head when the data access is completed;
performing the data access operation, waiting for the completion of the next data access when there is data access, and unloading said magnetic head to a load lamp outside of said medium when there is no data access;
checking whether there is data access within the time of stopping said spindle motor; and
updating the spin-down time Y1 to a value obtained by adding the difference t X between the time t from the last data access to the next data access and the current head unload time X and a value t0 for taking predetermined allowance to the current spin-down time Y, setting the next head unload time X1 at t t0, performing the next data access operation, and waiting for the next data access when there is data access, and returning the head unload time X and the spin-down time Y to the predetermined initial values X0 and Y0 from the next time and stopping said spindle motor when there is no data access.
